(19) United States
(12) Patent Application Publication
(10) Pub. No.: US 2025/0340123 A1
(43) Pub. Date: Nov. 6, 2025

(54) OUT-RUSH PROTECTION DEVICE FOR A BATTERY SYSTEM AND APPLICATIONS THEREOF

(71) Applicant: Electrovaya Inc., Mississauga (CA)

(72) Inventors: William Keith Baker, Inglewood (CA); Abdolhassan Shahrbanoozadeh, Brampton (CA); Harry Young, Guelph (CA)

(21) Appl. No.: 19/065,394

(22) Filed: Feb. 27, 2025

Related U.S. Application Data
(60) Provisional application No. 63/642,530, filed on May 3, 2024.

(51) Int. Cl. B60L 3/00; B60L 50/60; H01M 10/0525; H01M 10/06; H01M 10/42

(52) U.S. Cl. CPC B60L 3/0046; B60L 50/60; H01M 10/0525; H01M 10/06; H01M 10/425; B60L 2240/549; H01M 2010/4271; H01M 2220/20

(57) ABSTRACT

Systems and devices for out-rush/in-rush protection in electrochemical energy storage systems and devices (e.g., batteries) are described. In various embodiments, a system (e.g., electric vehicle) may include an electrical energy storage device/battery, a drive unit/electric motor/load configured to receive a current from the battery; and a control module coupled to the drive unit and the battery. The control module may be configured to control the current output from the battery to the drive unit/electric motor/load, wherein the control module may include a protection unit configured to increase an impedance of the battery upon a detection of an in-rush current event at the drive unit/electric motor/load, an out-rush current event at the battery, or for a period of time to protect the out-rush/in-rush event at the battery. The protection unit may be configured to reduce the impedance of the battery upon detecting that the out-rush/in-rush current event has subsided.

### CROSS REFERENCE TO RELATED APPLICATION

This application claims priority to U.S. Patent Application No. 63/642,530, filed May 3, 2024, all of which is incorporated by reference herein in its entirety.

### FIELD OF INVENTION

The disclosure relates to electrochemical energy storage systems and devices including rechargeable lithium-ion batteries, and more particularly related to systems and devices for out-rush/in-rush protection in the electrochemical energy storage systems and devices and electric vehicles that include the electrochemical energy storage systems or devices.

### BACKGROUND

The demand for rechargeable electrochemical energy storage systems and devices with improved performance, particularly related to charging and health of such systems/devices, is ever-increasing with the upticks in the accelerated adoption of passenger and commercial electric vehicles. Rising along with the commercial demand is the need for proper management and maintenance of these energy storage systems and devices. It is, however, not straightforward to manage these electrochemical energy storage systems and devices, or vehicles that deploy electrochemical energy storage systems and devices, at least with respect to the charging, discharging and/or general maintenance of these energy storage systems and devices in order to prolong their performance and longevity. Considering the above, the added challenge to the above lies in the fact that these energy storage systems and devices may be manufactured by different companies, which may use different systems or devices with vastly different battery chemistries, form factors with different physical dimensions and capacities, and/or often with different specificities in charge and discharge characteristics and limits applied to each unique energy storage system or device.

Even if the electrochemical parameters are similar in the energy storage systems and devices, their charge/discharge states or rates may be highly time dependent in their usage cycle. In other words, at any given time, the state of charge (SOC), state of health (SOH), operating voltages or current ratings for each of the energy storage systems and devices may be uniquely different from another one. Thus, in order to ensure proper management and maintenance of these energy storage systems and devices with respect to maintaining their high performance and longevity, and to avoid a complete system shutdown in some instances, there is a need for proper management and maintenance of these energy storage systems and devices. Specifically, there is a need for a hardware and/or a software solution to facilitate proper management and maintenance of energy storage systems and devices, which may have different battery chemistries, characteristics, performance, etc., to better accommodate unforeseen variations in time-dependent power, voltage, and current ratings and overall load asserted on these rechargeable electrochemical energy storage systems and devices.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 illustrates an embodiment of a system or an electric vehicle system, in accordance with various embodiments.

FIGS. 2A and 2B illustrate embodiments of a control module having a current/protection unit, in accordance with various embodiments.

FIG. 3 illustrates a block diagram of a computer system/processor used in the control module of FIGS. 1, 2A, and 2B, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

The following shall be a detailed description of the drawings which are given for the purposes of illustrating the preferred embodiments of the present invention, and not for the purpose of limiting the same. In accordance with one or more embodiments herein, an out-rush protection system/device/circuit/module is provided for high current electrochemical energy storage systems or devices, or electric or conventional vehicles, both commercial or personal in nature, that contain or utilize the electrochemical energy storage systems or devices. The out-rush protection system/device in such systems, devices or vehicles, may protect against high current events typically observed at the connection or contact point of loads or during a startup. In one or more embodiments, the out-rush protection system/device/circuit/module may be configured to increase an output impedance of the electrochemical energy storage systems or devices, which limits the current that can be sourced from the battery, and then maintain this impedance until an out-rush current event (typically the charging of a capacitive load) is detected. After such an out-rush current event is completed, the out-rush protection system/device/circuit/module may be configured such that the added impedance is reduced to a minimum. In one or more embodiments, the out-rush protection system/device may be configured such that a detection of the out-rush current event is performed by observing a brownout of output voltage from the electrochemical energy storage systems or devices. In one or more embodiments, the out-rush protection system/device/circuit/module may be configured such that a direct current measurement is performed through the added impedance within the out-rush protection system/device/circuit/module.

Some commercial or personal vehicles typically include and designed for lead acid batteries, which may have high levels of uncontrolled in-rush current. However, lead acid batteries in these vehicles typically do not have contactors because in-rush events in these batteries are typically short in duration as they are typically used to provide ancillary power to various electronic components and functions (e.g., power windows, entertainment system, etc.) in the vehicles. Thus, it is typically not a system level concern for internal combustion engine (ICE) vehicles, which are designed for lead acid batteries that lack a pre-charge circuitry that would help mitigate in-rush current events.

On the other hand, lithium-based rechargeable electrochemical energy storage systems or devices (e.g., lithium-based batteries) can be used in electric vehicles for high current applications, such as providing a high enough current to electric motors for vehicle movement/acceleration. Since acceleration requires a large amount of current that needs to be provided to the electric motors, the electrochemical energy storage systems or devices are typically designed with contactors to manage these high current events. In some cases, the high current events may cause levitation that can result in arcing at the contact points (e.g., contactors) between and the load (e.g., an electric or ICE vehicle) and the batteries (e.g., electrochemical cells or generally electrochemical energy storage systems or devices). In some instances, there may be one or more contactors attached to either or both ends of the battery. In some implementations, the contactors may include high-current mechanical switches or electromechanical switches. There can be multiple strings in some batteries, which can be connected in parallel, or in some cases, in a serial arrangement. In some instances, the negative end may be connected to a contactor and the positive side may also include its own individual contactor. In some instances, both ends may be connected to the output terminals of the overall battery or electrochemical cells. In some embodiments, the negative contactor may be placed on the bottom and another contactor on an opposite end, which may include a series resistor across the contactor to enable out-rush limiting to the electrochemical energy storage system. Upon making contacts, e.g., turning on the switch, the resistor may limit the current outflow until the load, e.g., any external load, is fully charged.

In various systems and implementations, a battery controller or a system controller may be included to manage the out-rush or in-rush events. The battery or system controller may be involved with safety aspects of electrochemical energy storage systems or devices. For example, when the output of the battery is connected to the load (e.g., an electric or ICE vehicle), the negative contactor may be contacted first with a series of resistors for a period of time and then the circuit may be closed. In various embodiments, the system controller may instruct one or both of the following actions: 1) instruct the negative (or positive in some instances) contactor to be contacted first with a series of resistors for a fixed period of time, and then close the pre-charge contactor before closing the main contactor to reduce the impedance; or 2) instruct the output current flow to be measured and then open the contact if the current has dropped below a certain preset level before finish charging. In other words, the battery/system controller may first activate the out-rush protection of the electrochemical energy storage systems or devices and deactivate the out-rush protection by closing the main contactor with a relay, and the deactivation may occur after a predetermined period of time, and/or after the out-rush current, which is being monitored, has fallen below a predetermined level.

When a motor controller is connected directly to the electrochemical energy storage systems or devices, it has a huge amount of capacitance, which may need to be charged fully before proceeding. If the contactors are closed, i.e., contacted, it may function like a shorted circuit, which could start welding the contacts to the contactor. Therefore, the motor controller may require in-rush limiting to prevent this unwanted current event from occurring. This is for discharging of the electrochemical energy storage systems or devices to the load, e.g., the electric motor. In other words, when the electrochemical energy storage systems or devices supply power to a load (e.g., electric motor or otherwise), the out-rush protection system can facilitate a smooth current outflow from the electrochemical energy storage systems or devices, instead of a spike in the current outflow, which may damage various parts of the entire system. To prevent a short circuit, the electrochemical energy storage systems or devices may include a control module which helps prevent electric vehicle systems, including electric trucks, from a current spike of several thousands of amperes, by measuring the current before reducing the impedance in the system, or monitoring the brown out output voltage.

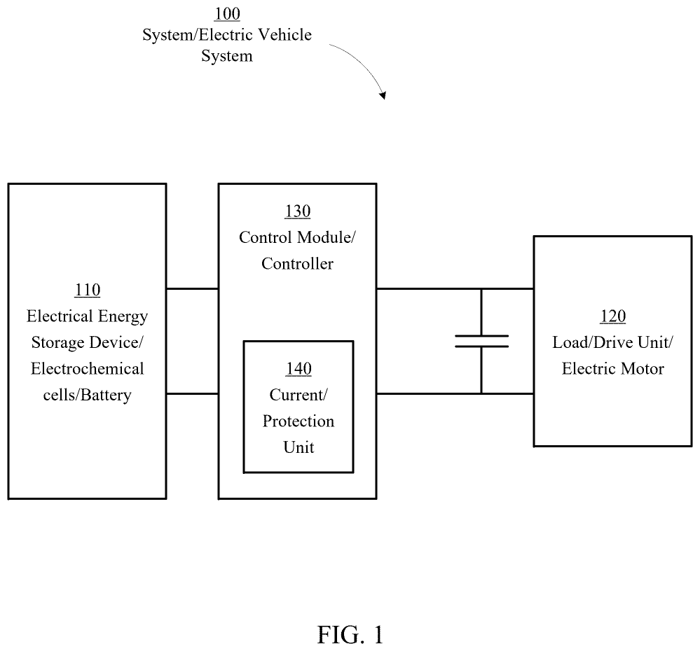

To better illustrate and describe the systems and devices for out-rush/in-rush protection in the electrochemical energy storage systems and devices and electric vehicles that include the electrochemical energy storage systems or devices, reference is now made to the following descriptions taken in conjunction with the accompanying FIGS. 1-3.

FIG. 1 illustrates an embodiment of a system or an electric vehicle system 100, in accordance with various embodiments. As illustrated in FIG. 1, the system/electric vehicle system 100 includes an electrical energy storage device 110 (also referred to herein as an electrical energy storage system or device, electrochemical cell, a plurality of electrochemical cells, or simply a battery), a load 120 (also referred to herein as a drive unit or an electric motor) configured to receive a current from the electrical energy storage device 110, and a control module 130 (also referred to herein as a controller) coupled to the load/drive unit/electric motor 120 and/or the electrical energy storage device 110. In one or more embodiments, the electrical energy storage device 110 may include a lithium-ion battery, a solid-state lithium-ion battery, or a lead acid battery.

In accordance with various embodiments, the control module 130 can be configured to control the current output from the electrical energy storage device 110 to the load/drive unit/electric motor 120. As illustrated in FIG. 1, the control module 130 may further include a current protection unit 140 (also referred to herein as protection unit 140) configured to increase an impedance of the electrical energy storage device 110 upon a detection of an in-rush current event at the load/drive unit/electric motor 120, in accordance with various embodiments. In one or more embodiments, the current protection unit 140 may be further configured to reduce the impedance of the electrical energy storage device 110 upon detecting that the in-rush current event has subsided.

In various embodiments of the system or electric vehicle system 100 in FIG. 1, the in-rush current event at the load/drive unit/electric motor 120 may include a high current event exceeding an electrical current of about 1000 amperes, about 1100 amperes, about 1200 amperes, about 1300 amperes, about 1400 amperes, about 1500 amperes, about 2000 amperes, or about 3000 amperes or more drawn from the electrical energy storage device 110, which may cause a high-power load to the electrical energy storage device 120. In various embodiments, the current protection unit 140 may be further configured to detect the in-rush current event at the load/drive unit/electric motor 120 via a current measurement. In various embodiments, the in-rush current event further may include a low current event occurred after the high current event has subsided from the high-power load to the electrical energy storage device 110. In various embodiments, the in-rush current event may be detected via a measurement of a brownout of an output voltage of the electrical energy storage device 110.

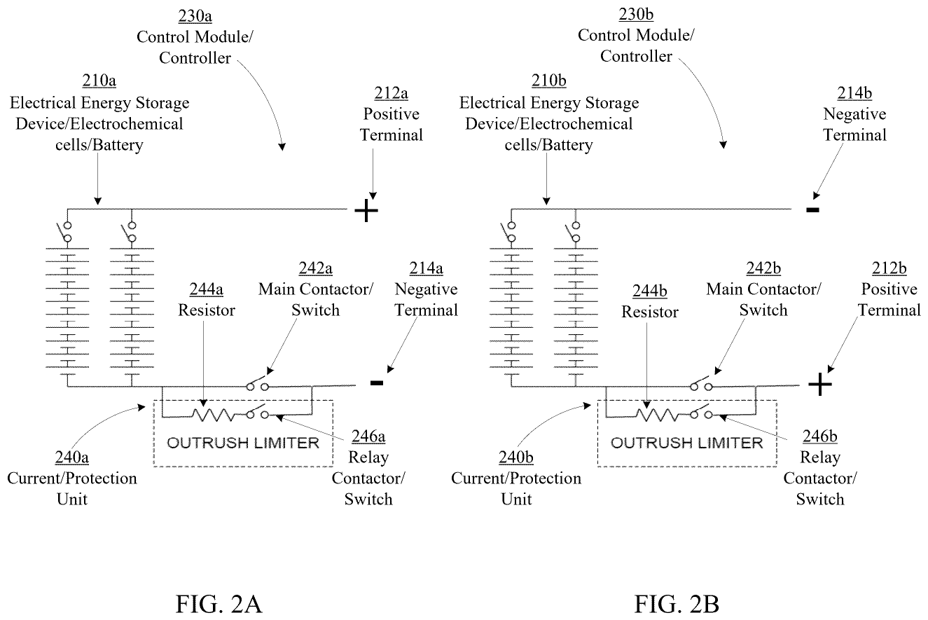

To describe in further details of the current protection unit 140, FIGS. 2A and 2B respectively illustrate embodiments of control modules/controllers 230a and 230b having respective current protection units 240a and 240b (or generally referred to herein as protection units 240a and 240b), in accordance with various embodiments. As illustrated in FIGS. 2A and 2B, the control modules/controllers 230a and 230b respectively includes the current/protection units 240a and 240b. FIG. 2A shows an embodiment where the current/protection unit 240a includes one or more electrical energy storage devices 210a having a positive terminal 212a on one end and a negative terminal 214a on another end. As illustrated in FIG. 2A, the current/protection unit 240a is a circuit that includes a main contactor/switch 242a in a parallel arrangement with a series resistor 244a and a relay contactor/switch 246a on the negative terminal 214a. FIG. 2B shows another embodiment where the current/protection unit 240b includes one or more electrical energy storage devices 210b having a positive terminal 212b on one end and a negative terminal 214b on another end. As illustrated in FIG. 2B, the current/protection unit 240b is a circuit that includes a main contactor/switch 242b in a parallel arrangement with a series resistor 244b and a relay contactor/switch 246b on the positive terminal 212b. In another word, the current protection unit 240a/b includes a resistor 244a/b connected in series with either a positive terminal 212a/b or a negative terminal 214a/b of the electrical energy storage device 210a/b via a relay contactor/switch 246a/b (e.g., an electromechanical switch). In doing so, the current protection unit 240a/b may increase the impedance in the circuit by connecting the relay contactor/switch 246a/b (e.g., an electromechanical switch) to the positive terminal 212a/b or the negative terminal 214a/b of the electrical energy storage device 210a/b such that the resistor 244a/b may create a high impedance at either the positive terminal 212a/b or the negative terminal 214a/b of the electrical energy storage device 210a/b. In one or more embodiments, the electrical energy storage device 210a/b may include a lithium-ion battery, a solid-state lithium-ion battery, or a lead acid battery.

In various embodiments, a system may include an electrical energy storage device, such as electrical energy storage device 110 or 210a/b, a load, such as a drive unit or an electric motor, may be configured to receive power from the electrical energy storage device, and a controller, such as the control module 130 or 230a/b, coupled to the load and/or the electrical energy storage device. In one or more embodiments, the controller may be configured to control the power output from the electrical energy storage device to the load, wherein the controller may include a protection unit, such as the current/protection unit 140 or 240a/b, configured to increase an impedance of the electrical energy storage device upon a detection of an out-rush current event at the electrical energy storage device. In one or more embodiments, the protection unit may be further configured to reduce the impedance of the electrical energy storage device upon detecting that the out-rush current event has subsided.

In one or more embodiments, the out-rush current event at the electrical energy storage device may include a high current event exceeding an electrical current of about 1000 amperes, about 1100 amperes, about 1200 amperes, about 1300 amperes, about 1400 amperes, about 1500 amperes, about 2000 amperes, or about 3000 amperes or more drawn from the electrical energy storage device that may cause a high-power load to the electrical energy storage device. In one or more embodiments, the protection unit may be further configured to detect the out-rush current event at the electrical energy storage device via a current measurement. In one or more embodiments, the out-rush current event may further include a low current event occurred after the high current event has subsided from the high-power load to the electrical energy storage device. In one or more embodiments, the out-rush current event may be detected via a measurement of a brownout of an output voltage of the electrical energy storage device.

In one or more embodiments, the protection unit may include a resistor connected in series with either a positive terminal or a negative terminal of the electrical energy storage device via an electromechanical switch. In one or more embodiments, the protection unit may increase the impedance by connecting the electromechanical switch to the positive terminal or the negative terminal of the electrical energy storage device such that the resistor creates a high impedance at either the positive terminal or the negative terminal of the electrical energy storage device. In one or more embodiments, the electrical energy storage device of the system may include a lithium-ion battery, a solid-state lithium-ion battery, or a lead acid battery.

In one or more embodiments, a vehicle may include an electrical energy storage device, an electric motor configured to receive a current from the electrical energy storage device, and a control module coupled to the electric motor and/or the electrical energy storage device. In one or more embodiments, the control module may be configured to control the current output from the electrical energy storage device to the electric motor. In one or more embodiments, the control module may include a current protection unit configured to increase an impedance of the electrical energy storage device for a period of time to protect an out-rush event at the electrical energy storage device and reduce the impedance after the period of time has expired.

In one or more embodiments, the out-rush current event at the electrical energy storage device may include a high current event exceeding an electrical current of about 1000 amperes, about 1100 amperes, about 1200 amperes, about 1300 amperes, about 1400 amperes, about 1500 amperes, about 2000 amperes, or about 3000 amperes or more drawn from the electrical energy storage device that causes a high-power load to the electrical energy storage device. In one or more embodiments, the current protection unit may be further configured to monitor the out-rush current event at the electrical energy storage device via a current measurement. In one or more embodiments, the out-rush current event may further include a low current event occurred after the high current event has subsided from the high-power load to the electrical energy storage device. In one or more embodiments, the out-rush current event can be monitored via a measurement of a brownout of an output voltage of the electrical energy storage device. In one or more embodiments, the current protection unit may include a resistor connected in series with either a positive terminal or a negative terminal of the electrical energy storage device via an electromechanical switch, and wherein the protection unit increases the impedance by connecting the electromechanical switch to the positive terminal or the negative terminal of the electrical energy storage device such that the resistor creates a high impedance at either the positive terminal or the negative terminal of the electrical energy storage device. In one or more embodiments, the electrical energy storage device of the vehicle may include a lithium-ion battery, a solid-state lithium-ion battery, or a lead acid battery.

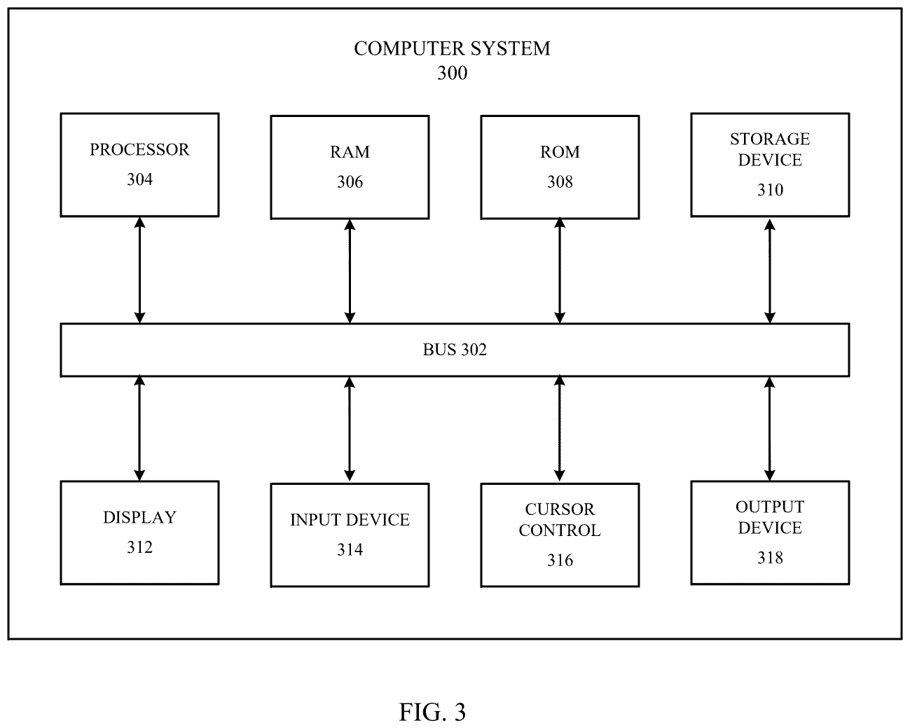

FIG. 3 illustrates a block diagram of a computer system/processor 300 used in a control module similar to, for example, the control modules/controllers 130, 230a, and 230b, respectively, of FIGS. 1, 2A, and 2B, in accordance with various embodiments. Computer system 300 may be used as a processor in control modules/controllers 130, 230a, and 230b as described with respect to FIGS. 1, 2A, and 2B, as described further below, with respect to FIG. 3.

In one or more examples, computer system 300 can include a bus 302 or other communication mechanism for communicating information, and a processor 304 coupled with bus 302 for processing information. In various embodiments, computer system 300 can also include a memory, which can be a random-access memory (RAM) 306 or other dynamic storage device, coupled to bus 302 for determining instructions to be executed by processor 304. Memory also can be used for storing temporary variables or other intermediate information during execution of instructions to be executed by processor 304. In various embodiments, computer system 300 can further include a read only memory (ROM) 308 or other static storage device coupled to bus 302 for storing static information and instructions for processor 304. A storage device 310, such as a magnetic disk or optical disk, can be provided and coupled to bus 302 for storing information and instructions.

In various embodiments, computer system 300 can be coupled via bus 302 to a display 312, such as a cathode ray tube (CRT), liquid crystal display (LCD), or light emitting diode (LED) for displaying information to a computer user. An input device 314, including alphanumeric and other keys, can be coupled to bus 302 for communicating information and command selections to processor 304. Another type of user input device is a cursor control 316, such as a mouse, a joystick, a trackball, a gesture input device, a gaze-based input device, or cursor direction keys for communicating direction information and command selections to processor 304 and for controlling cursor movement on display 312. This input device 314 typically has two degrees of freedom in two axes, a first axis (e.g., x) and a second axis (e.g., y), that allows the device to specify positions in a plane. However, it should be understood that input devices 314 allowing for three-dimensional (e.g., x, y, and z) cursor movement are also contemplated herein.

Consistent with certain implementations of the present teachings, results can be provided by computer system 300 in response to processor 304 executing one or more sequences of one or more instructions contained in RAM 306. Such instructions can be read into RAM 306 from another computer-readable medium or computer-readable storage medium, such as storage device 310. Execution of the sequences of instructions contained in RAM 306 can cause processor 304 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 304 for execution. Such a medium can take many forms, including but not limited to, non-volatile media, volatile media, and transmission media. Examples of non-volatile media can include, but are not limited to, optical, solid state, magnetic disks, such as storage device 310. Examples of volatile media can include, but are not limited to, dynamic memory, such as RAM 306. Examples of transmission media can include, but are not limited to, coaxial cables, copper wire, and fiber optics, including the wires that comprise bus 302.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 304 of computer system 300 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 300 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 300, whereby processor 304 would execute the analyses and determinations provided by these engines, subject to instructions provided by any one of, or a combination of, the memory components RAM 306, ROM, 308, or storage device 310 and user input provided via input device 314.

### RECITATION OF EMBODIMENTS

Embodiment 1. An electric vehicle system, comprising: an electrical energy storage device; a drive unit configured to receive a current from the electrical energy storage device; and a control module coupled to the drive unit and/or the electrical energy storage device, the control module configured to control the current output from the electrical energy storage device to the drive unit, wherein the control module comprises a current protection unit configured to increase an impedance of the electrical energy storage device upon a detection of an in-rush current event at the drive unit, and wherein the current protection unit is further configured to reduce the impedance of the electrical energy storage device upon detecting that the in-rush current event has subsided.

Embodiment 2. The electric vehicle system of Embodiment 1, wherein the in-rush current event at the drive unit comprises a high current event exceeding an electrical current of 1000 amperes drawn from the electrical energy storage device that causes a high-power load to the electrical energy storage device.

Embodiment 3. The electric vehicle system of Embodiment 2, wherein the current protection unit is further configured to detect the in-rush current event at the drive unit via a current measurement.

Embodiment 4. The electric vehicle system of Embodiment 3, wherein the in-rush current event further comprises a low current event occurred after the high current event has subsided from the high-power load to the electrical energy storage device.

Embodiment 5. The electric vehicle system of any one of Embodiments 1-4, wherein the in-rush current event is detected via a measurement of a brownout of an output voltage of the electrical energy storage device.

Embodiment 6. The electric vehicle system of any one of Embodiments 1-5, wherein the current protection unit comprises a resistor connected in series with either a positive terminal or a negative terminal of the electrical energy storage device via an electromechanical switch, and wherein the current protection unit increases the impedance by connecting the electromechanical switch to the positive terminal or the negative terminal of the electrical energy storage device such that the resistor creates a high impedance at either the positive terminal or the negative terminal of the electrical energy storage device.

Embodiment 7. The electric vehicle system of any one of Embodiments 1-6, wherein the electrical energy storage device comprises a lithium-ion battery, a solid-state lithium-ion battery, or a lead acid battery.

Embodiment 8. A system, comprising: an electrical energy storage device; a load configured to receive power from the electrical energy storage device; and a controller coupled to the load and/or the electrical energy storage device, the controller configured to control the power output from the electrical energy storage device to the load, wherein the controller comprises a protection unit configured to increase an impedance of the electrical energy storage device upon a detection of an out-rush current event at the electrical energy storage device, and wherein the protection unit is further configured to reduce the impedance of the electrical energy storage device upon detecting that the out-rush current event has subsided.

Embodiment 9. The system of Embodiment 8, wherein the out-rush current event at the electrical energy storage device comprises a high current event exceeding an electrical current of 1000 amperes drawn from the electrical energy storage device that causes a high-power load to the electrical energy storage device.

Embodiment 10. The system of Embodiment 9, wherein the protection unit is further configured to detect the out-rush current event at the electrical energy storage device via a current measurement.

Embodiment 11. The system of Embodiment 10, wherein the out-rush current event further comprises a low current event occurred after the high current event has subsided from the high-power load to the electrical energy storage device.

Embodiment 12. The system of any one of Embodiments 8-11, wherein the out-rush current event is detected via a measurement of a brownout of an output voltage of the electrical energy storage device.

Embodiment 13. The system of any one of Embodiments 8-12, wherein the protection unit comprises a resistor connected in series with either a positive terminal or a negative terminal of the electrical energy storage device via an electromechanical switch, and wherein the protection unit increases the impedance by connecting the electromechanical switch to the positive terminal or the negative terminal of the electrical energy storage device such that the resistor creates a high impedance at either the positive terminal or the negative terminal of the electrical energy storage device.

Embodiment 14. The system of any one of Embodiments 8-13, wherein the electrical energy storage device comprises a lithium-ion battery, a solid-state lithium-ion battery, or a lead acid battery.

Embodiment 15. A vehicle, comprising: an electrical energy storage device; an electric motor configured to receive a current from the electrical energy storage device; and a control module coupled to the electric motor and/or the electrical energy storage device, the control module configured to control the current output from the electrical energy storage device to the electric motor, wherein the control module comprises a current protection unit configured to increase an impedance of the electrical energy storage device for a period of time to protect an out-rush event at the electrical energy storage device and reduce the impedance after the period of time has expired.

Embodiment 16. The vehicle of Embodiment 15, wherein the out-rush current event at the electrical energy storage device comprises a high current event exceeding an electrical current of 1000 amperes drawn from the electrical energy storage device that causes a high-power load to the electrical energy storage device.

Embodiment 17. The vehicle of Embodiment 16, wherein the current protection unit is further configured to monitor the out-rush current event at the electrical energy storage device via a current measurement.

Embodiment 18. The vehicle of Embodiment 17, wherein the out-rush current event further comprises a low current event occurred after the high current event has subsided from the high-power load to the electrical energy storage device.

Embodiment 19. The vehicle of any one of Embodiments 15-18, wherein the out-rush current event is monitored via a measurement of a brownout of an output voltage of the electrical energy storage device.

Embodiment 20. The vehicle of any one of Embodiments 15-19, wherein the current protection unit comprises a resistor connected in series with either a positive terminal or a negative terminal of the electrical energy storage device via an electromechanical switch, and wherein the protection unit increases the impedance by connecting the electromechanical switch to the positive terminal or the negative terminal of the electrical energy storage device such that the resistor creates a high impedance at either the positive terminal or the negative terminal of the electrical energy storage device.

Embodiment 21. The vehicle of any one of Embodiments 15-20, wherein the electrical energy storage device comprises a lithium-ion battery, a solid-state lithium-ion battery, or a lead acid battery.

1. An electric vehicle system, comprising:
an electrical energy storage device;
a drive unit configured to receive a current from the electrical energy storage device; and
a control module coupled to the electrical energy storage device, the control module configured to control the current output from the electrical energy storage device to the drive unit,
wherein the control module comprises a current protection unit configured to increase an impedance of the electrical energy storage device upon a detection of an in-rush current event at the drive unit, and
wherein the current protection unit is further configured to reduce the impedance of the electrical energy storage device upon detecting that the in-rush current event has subsided.

2. The electric vehicle system of claim 1, wherein the in-rush current event at the drive unit comprises a high current event exceeding an electrical current of 1000 amperes drawn from the electrical energy storage device that causes a high-power load to the electrical energy storage device.

3. The electric vehicle system of claim 2, wherein the current protection unit is further configured to detect the in-rush current event at the drive unit via a current measurement.

4. The electric vehicle system of claim 3, wherein the in-rush current event further comprises a low current event occurred after the high current event has subsided from the high-power load to the electrical energy storage device.

5. The electric vehicle system of claim 1, wherein the in-rush current event is detected via a measurement of a brownout of an output voltage of the electrical energy storage device.

6. The electric vehicle system of claim 1, wherein the current protection unit comprises a resistor connected in series with either a positive terminal or a negative terminal of the electrical energy storage device via an electromechanical switch, and wherein the current protection unit increases the impedance by connecting the electromechanical switch to the positive terminal or the negative terminal of the electrical energy storage device such that the resistor creates a high impedance at either the positive terminal or the negative terminal of the electrical energy storage device.

7. The electric vehicle system of claim 1, wherein the electrical energy storage device comprises a lithium-ion battery, a solid-state lithium-ion battery, or a lead acid battery.

8. A system, comprising:
an electrical energy storage device;
a load configured to receive power from the electrical energy storage device; and
a controller coupled to the electrical energy storage device, the controller configured to control the power output from the electrical energy storage device to the load,
wherein the controller comprises a protection unit configured to increase an impedance of the electrical energy storage device upon a detection of an out-rush current event at the electrical energy storage device, and
wherein the protection unit is further configured to reduce the impedance of the electrical energy storage device upon detecting that the out-rush current event has subsided.

9. The system of claim 8, wherein the out-rush current event at the electrical energy storage device comprises a high current event exceeding an electrical current of 1000 amperes drawn from the electrical energy storage device that causes a high-power load to the electrical energy storage device.

10. The system of claim 9, wherein the protection unit is further configured to detect the out-rush current event at the electrical energy storage device via a current measurement.

11. The system of claim 10, wherein the out-rush current event further comprises a low current event occurred after the high current event has subsided from the high-power load to the electrical energy storage device.

12. The system of claim 8, wherein the out-rush current event is detected via a measurement of a brownout of an output voltage of the electrical energy storage device.

13. The system of claim 8, wherein the protection unit comprises a resistor connected in series with either a positive terminal or a negative terminal of the electrical energy storage device via an electromechanical switch, and wherein the protection unit increases the impedance by connecting the electromechanical switch to the positive terminal or the negative terminal of the electrical energy storage device such that the resistor creates a high impedance at either the positive terminal or the negative terminal of the electrical energy storage device.

14. The system of claim 8, wherein the electrical energy storage device comprises a lithium-ion battery, a solid-state lithium-ion battery, or a lead acid battery.

15. A vehicle, comprising:
an electrical energy storage device;
an electric motor configured to receive a current from the electrical energy storage device; and
a control module coupled to the electrical energy storage device, the control module configured to control the current output from the electrical energy storage device to the electric motor,
wherein the control module comprises a current protection unit configured to increase an impedance of the electrical energy storage device for a period of time to protect an out-rush event at the electrical energy storage device and reduce the impedance after the period of time has expired.

16. The vehicle of claim 15, wherein the out-rush current event at the electrical energy storage device comprises a high current event exceeding an electrical current of 1000 amperes drawn from the electrical energy storage device that causes a high-power load to the electrical energy storage device.

17. The vehicle of claim 16, wherein the current protection unit is further configured to monitor the out-rush current event at the electrical energy storage device via a current measurement.

18. The vehicle of claim 17, wherein the out-rush current event further comprises a low current event occurred after the high current event has subsided from the high-power load to the electrical energy storage device.

19. The vehicle of claim 15, wherein the out-rush current event is monitored via a measurement of a brownout of an output voltage of the electrical energy storage device.

20. The vehicle of claim 15, wherein the current protection unit comprises a resistor connected in series with either a positive terminal or a negative terminal of the electrical energy storage device via an electromechanical switch, and wherein the protection unit increases the impedance by connecting the electromechanical switch to the positive terminal or the negative terminal of the electrical energy storage device such that the resistor creates a high impedance at either the positive terminal or the negative terminal of the electrical energy storage device.
